(19) United States
(12) Patent Application Publication
(10) Pub. No.: US 2012/0030421 A1
(43) Pub. Date: Feb. 2, 2012

(54) MAINTAINING STATES FOR THE REQUEST QUEUE OF A HARDWARE ACCELERATOR

(75) Inventors: Xiao Tao Chang, Beijng (CN); Huo Ding Li, Beijing (CN); Xiaolu Mei, Shanghai (CN); Ru Yun Zhang, (US)

(73) Assignee: INTERNATIONAL BUSINESS MACHINES CORPORATION, New York, NY (US)

(21) Appl. No.: 13/108,263

(22) Filed: May 16, 2011

(30) Foreign Application Priority Data
Jul. 30, 2010 (CH) 201010244498.8

(51) Int. Cl. G06F 12/00

(52) U.S. Cl. 711/108; 711/E12.001

(57) ABSTRACT

The invention discloses a method and system of maintaining states for the request queue of a hardware accelerator, wherein the request queue stores therein at least one Coprocessor Request Block (CRB) to be input into the hardware accelerator, the method comprising: receiving, in response to a CRB specified by the request queue is about to enter the hardware accelerator, the state pointer of the specified CRB; acquiring physical storage locations of other CRBs in the request queue that are stored in the request queue and are the same as the state pointer of the specified CRB; controlling the input of the specified CRB and the state information required for processing the specified CRB into a hardware buffer; receiving the state information of the specified CRB that has been processed in the hardware accelerator; if the above physical storage locations are not vacant, then making physical storage locations that are closest on the request queue of the specified CRB as the selected location and storing the received state information in the selected location of the state buffer.

### TECHNICAL FIELD OF THE INVENTION

The invention generally relates to signal processing, and more particularly, to a method and system of maintaining states for request queue of a hardware accelerator.

### BACKGROUND OF THE INVENTION

Constitution of CMP (chip multiprocessors) is divided into two types: homogeneous and heterogeneous, in which homogeneous refers to that structure of internal cores that are the same, and heterogeneous, which refers to that structure of internal cores that are different.

FIG. 1 shows a modular structure of a heterogeneous multi-core processor chip 100. In FIG. 1, the CPU is a general purpose processor, Ethernet Media Access Controller (EMAC) including EMAC0, EMAC1 and EMAC2 (all of which are network accelerating processors) together with hardware accelerators are dedicated processors. A hardware accelerator is widely used in multi-core processors, especially for computing intensive applications, such as communication, financial service, energy resource, manufacturing, chemistry and the like. Currently, hardware accelerators integrated into some multi-core processor chips mainly include compressing/decompressing accelerators, encoding/decoding accelerators, mode matching accelerators, XML parse accelerators and the like. The memory controller in FIG. 1 is used to control cooperative functionality between the chip and memory, and a request queue is used to store requests that have been received but have not yet been processed by accelerators.

Next, taking the application of a Virtual Private Network (VPN) in telecommunication data, for example, data flow in chips shown in FIG. 1, as well as how each module cooperates, will be described. Those skilled in the art will recognize that, in other applications where messages need to be quickly processed, such as in financial service, energy resource, manufacturing, chemistry and the like, the problem is similar. In a VPN application within telecommunication data, one or more telecommunication servers are used to process the received original or encrypted packets and sending the packets out after the packets are encrypted or decrypted. Specifically, an EMAC module of multi-core processor chips in the server receives a plurality of packets to be encrypted or decrypted, then the CPU re-encapsulates them as a coprocessor request block (CRB) after information related to a network protocol of each packet is removed, CRB itself is not a packet but includes information such as the relevant location of specified data, etc., and CRB is placed in the request queue and asks the hardware accelerator to encrypt or decrypt data specified by the CRB. After the hardware accelerator receives the request, it encrypts or decrypts data blocks specified by the CRB and returns the encryption or decryption result to the CPU, such that the CPU may forward the data block to a corresponding user.

A VPN application in telecommunication will receive countless encryption or decryption requests, thus, the processing speed for messages has to be very fast. Generally speaking, although processing speed of software is very fast, it still needs a special purpose processor; the cost of which is very high; further, the processing speed of software sometimes barely satisfies real-time requirements of telecommunication applications; thus, in telecommunications, a hardware accelerator on multi-core processor chips shown in FIG. 1 may be employed to accomplish encryption or decryption. However, for such applications, when the hardware accelerator encrypts or decrypts data specified by the next CRB, it needs the state of the data specified by the previous CRB. Therefore, except for the state of the last CRB of a message, the state of other CRBs of the messages and data specified by all CRBs needs to be stored in memory.

As such, when a hardware accelerator processes CRB of the request queue, it not only needs to acquire data specified by CRB from memory, but also needs to store the state of the data specified by CRB in memory repeatedly and acquire the state of the stored data specified by CRB, thereby slowing processing speeds of whole chip and lowering efficiency.

### SUMMARY OF THE INVENTION

A hardware accelerator in the art needs to frequently access memory, the time to access memory is very long as compared to the process time of the CPU, such that the process efficiency of the whole chip and, therefore, the server system, is very low and more energy resources are consumed. Therefore, what is needed is a method and system capable of improving the process efficiency of the above-described hardware accelerator.

According to an aspect of the present invention, there is provided a system of maintaining the states for the request queue of a hardware accelerator, wherein the request queue stores therein at least one CRB to be input into the hardware accelerator, the system comprising:
a content addressable memory coupled to the request queue for, in response to a CRB specified by the request queue is about to enter the hardware accelerator, receiving the state pointer of the specified CRB and outputting physical storage locations of other CRBs in the request queue that are stored in the content addressable memory and are the same as the state pointer of the specified CRB, wherein the content addressable memory stores the state pointer of each CRB in the request queue in the same physical storage location as that of the request queue;
a state buffer having the same size as that of the request queue, each location thereof stores the state information required for processing CRB of the same location in the request queue; and
a control module configured to, in response to the specified CRB is about to enter the hardware accelerator, acquire from the content addressable memory physical storage locations of other CRBs in the request queue that are stored in the request queue and are the same as the state pointer of the specified CRB; control inputting of the specified CRB and the state information required to process the specified CRB into a hardware buffer; receive the state information of the specified CRB that has been processed in the hardware accelerator; if the above physical storage locations are not vacant, then make physical storage locations that are closest to the request queue of the specified CRB as the selected location and storing the received state information in the selected location of the state buffer.

According to another aspect of the invention, there is provided a method of maintaining the states for the request queue of a hardware accelerator, wherein the request queue stores therein at least one CRB to be input into the hardware accelerator, the method comprising:
receiving, in response to a CRB specified by the request queue that is about to enter the hardware accelerator, state pointer of the specified CRB;
acquiring physical storage locations of other CRBs in the request queue that are stored in the request queue and are the same as the state pointer of the specified CRB;
controlling inputting of the specified CRB and the state information required for processing the specified CRB into a hardware buffer;
receiving the state information of the specified CRB that has been processed in the hardware accelerator;
if the above physical storage locations are not vacant, then making physical storage locations that are closest to the request queue of the specified CRB as the selected locations and storing the received state information in the selected location of the state buffer, wherein the size of the state buffer is the same as that of the request queue, each location thereof stores state information required for processing CRB of the same location in the request queue.

According to still another aspect of the invention, there is provided a chip comprising the system of maintaining the states for the request queue of a hardware accelerator described above.

### BRIEF DESCRIPTION OF THE DRAWINGS

The above and other objects, features and advantages of the invention will become more apparent from the more detailed description of exemplary embodiments of the invention in the accompany drawings; wherein same or similar reference number in the accompany drawings generally represent same or similar elements in the exemplary embodiments of the invention, in which:

FIG. 1 shows a modular structure of a heterogeneous multi-core processor chip 100;

FIG. 2 illustratively shows the structure of an existing CRB;

FIG. 3 shows a schematic diagram of CRB arrangement in the request queue taking the received three messages in the request queue as an example;

FIG. 4 shows a schematic diagram of CRB distribution of the above three messages;

FIG. 5 shows the existing state of CRB of respective messages in the request queue and the procedure of interacting with memory for storing and retrieving the state information during processing;

FIG. 6 illustratively shows a structural diagram of a system for maintaining the states for the request queue of a hardware accelerator according to one embodiment of the invention;

FIG. 7 shows a specific example of the embodiment of FIG. 6;

FIG. 8 shows a structural diagram of an extended CRB;

FIG. 9 shows a structural diagram of a system of maintaining the states for the request queue of a hardware accelerator according to another embodiment of the invention;

FIG. 10 shows a flowchart of a method of maintaining the states for the request queue of a hardware accelerator according to an embodiment of the invention;

FIG. 11 shows the detailed steps of step S1003;

FIG. 12 shows the flow of inserting a new CRB in a location specified by a tail pointer of the request queue; and

FIG. 13 shows the detailed steps of step S1204.

### DETAILED DESCRIPTION OF THE PREFERRED EMBODIMENTS

Preferred embodiments of the present invention will be described in detail with reference to the drawings in which preferred embodiments are shown. However, the invention can be realized in various forms and should not be construed as limited to embodiments described herein. Rather, these embodiments are provided to enable the invention to be more apparent and complete and fully convey the scope of the invention to those skilled in the art.

First, the principle of encryption/decryption of the packet in VPN will be briefly introduced. VPN is defined as a temporary, secure connection established through a public network (Internet), it is a secure, stable tunnel passing through chaotic public networks. VPN can establish a private communication line between two or more enterprise intranets connected to the Internet and located at different places through a special encrypted communication protocol, as if a private line is set up; however, it does not need to really lay down physical lines, such as optical cable. Symmetrical encryption and asymmetrical encryption may be used in VPN. For simplicity, here the description will take symmetrical encryption for an example. Symmetrical encryption means that keys for encryption and decryption are the same.

During encryption, for a segment of plain text, e.g. the plain text of a packet is 123456789ABCDEFGHIJKLMN . . . , assume the encryption key is password and assume that the data length of each encryption is 8. The first required operation is performed on key password and the first 8 bits of the packet to generate the cipher text. Assume that the cipher text is EDNCMNYB, the encryption key of the next 8 bits 9ABCDEFG is then generated by using that cipher text, the key is again used to encrypt 9ABCDEFG, and so on. That is, the encryption key of each piece of 8 bit plain text data is different and depends on the cipher text of the previous 8 bits of data. In other words, it can be considered that the encryption key of each piece of 8 bit plain text data is just the state required for processing the 8 bits of data, the state depends on the process result of the previous 8 bits of data. Here the data length of each encryption is illustrative and, in specific applications, the data length of encryption also needs to be set according to the encryption algorithm and other requirements.

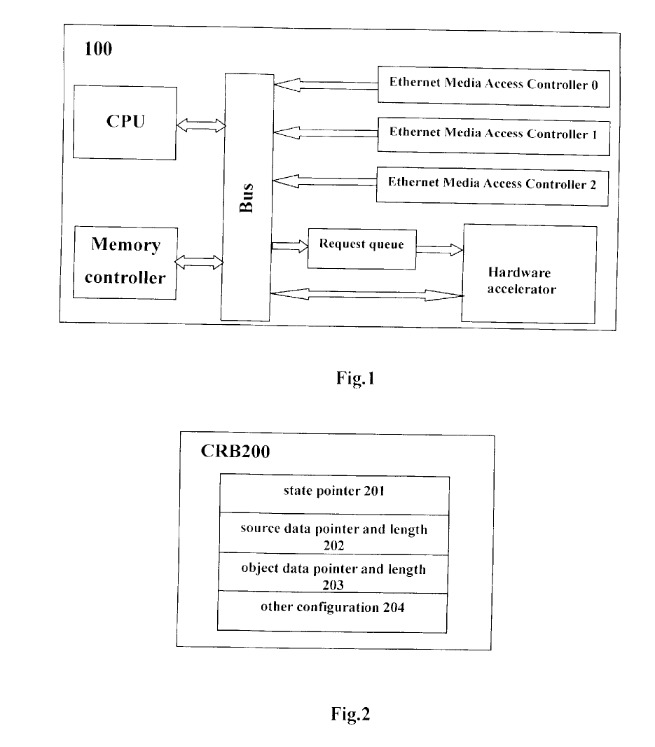

FIG. 1 shows a modular structure of a heterogeneous multi-core processor chip 100. During the process of processing the above VPN encrypted/decrypted packets by the heterogeneous multi-core processor chip shown in FIG. 1, after the network protocol related information of the received packet is removed by the CPU, the data information is stored in memory and the storage location related information of the data information in memory is packaged into CRB and sent to the request queue for processing by the hardware accelerator. FIG. 2 illustratively shows a structure of an existing CRB corresponding to encryption or decryption applications, in which CRB 200 contains state pointer 201, source data (source data is plain text for encryption process, and source data is cipher text for decryption process) pointer and length 202, object data pointer (object data is cipher text for encryption process, and object data is plain text for decryption process) and length 203 and other configurations 204. State pointer 201 is the state reserved after the data specified by the current CRB is processed, i.e. the key for processing the data specified by CRB of next same message. The pointer to the initial location of the state information is stored in memory so that the state information may be acquired and used according to the initial location when the data specified by the next CRB is processed. A message may contain a plurality of CRBs, but a message only needs to reserve the storage location of one piece of state information in memory. Because current CRBs can be processed as long as the state information of the previous CRB is reserved, the next CRB can be processed when the state information of the current CRB is still reserved in the storage location of the state information, and the state information of the previous CRB is no longer needed. For example, for the encryption or decryption process of the data specified by CRB using a hardware accelerator, if each encryption key of data specified by each CRB is not the same, the state information may be the encryption key of the data specified by the CRB; and so on. The source data pointer and length 202 is the pointer to the storage location of the initial data specified by the CRB in memory and the length of the initial data specified by the CRB; the object data pointer and length 203 is the pointer to the storage location of the processed data specified by the CRB in memory and the length of the processed data specified by the CRB; other configuration 204 may be configured according to the requirement of the application. The data specified by each CRB, including source data (such as compressed data) and object data (such as decompressed data), is placed in memory according to the storage location specified by CRB, i.e. the location specified by the data pointer.

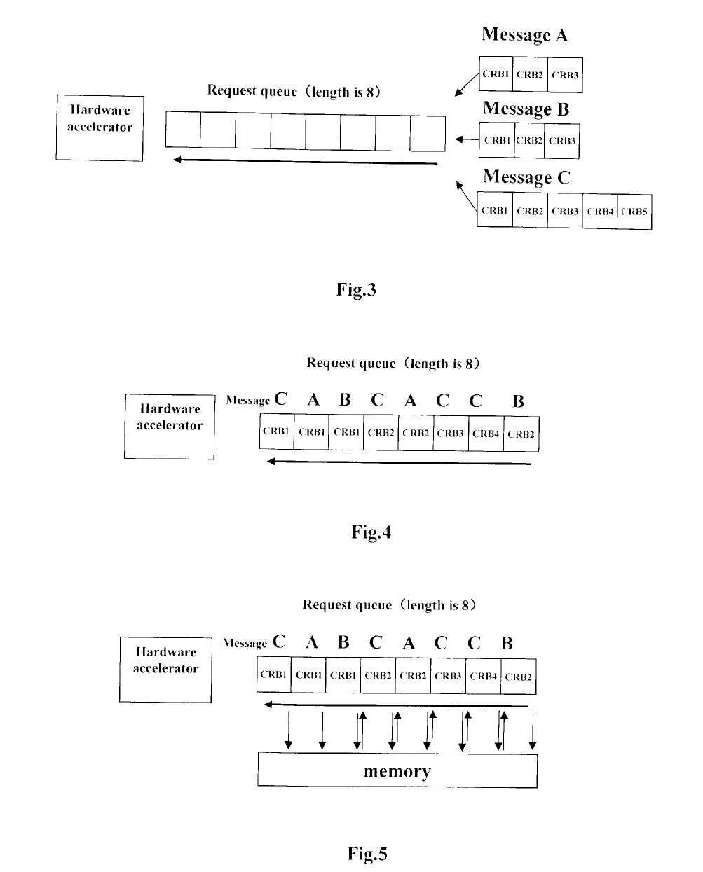

FIG. 3 shows a schematic diagram of CRB arrangement in the request queue taking the three messages received in the request queue as an example, the three messages are message A (including 3 CRBs), message B (including 3 CRBs) and message C (including 5 CRBs), respectively. Here, assume the length of the request queue is 8 CRBs.

Distribution of CRBs of the respective messages in the request queue is decided by the order of the packets received at the CPU. FIG. 4 shows a schematic diagram of CRB distribution of the above three messages. In prior art, hardware accelerators decompress the data specified by each CRB sequentially according to the order of CRBs in the request queue as shown in FIG. 4.

Taking encryption/decryption application for an example, since the state information of the relevant CRB is needed in the encryption/decryption procedure, for example, during the encryption process, the first CRB of message A may be directly encrypted with the encryption key and for the second CRB of message A, a new key formed after the first CRB is processed is needed during the encryption, for the third CRB of message A, a new key formed after the second CRB is processed is needed during the encryption, and so on. Thus, the hardware accelerator cannot decrypt all CRBs in case the request queue in FIG. 1 only contains respective CRB, in actual design, the relevant CRB state is stored in memory and is retrieved from memory, as needed. Further, when CRBs of respective messages entering into a telecommunication server, CPU of multi-core processor of the server may control, for each message, its CRB enters into the data queue according to a time sequence, that is, first CRB of message A arrives earlier than the second CRB of message A, second CRB of message A arrives earlier than the third CRB of message A, etc.; however, there is no logical order among CRBs of respective messages.

FIG. 5a shows the state of the existing CRB of the respective message in the request queue and the procedure of interacting with the memory for storing and retrieving the state information during processing. According to FIG. 5, when the first CRB of the message C is encrypted, the hardware accelerator needs to store the state of the CRB in memory (writing in memory); when the first CRB of message A arrives, the hardware accelerator also needs to store the state of the CRB in memory (writing in memory); when the first CRB of message B arrives, the hardware accelerator also needs to store the state of the CRB in memory (writing in memory). Then, when the second CRB of the message C arrives, the hardware accelerator first needs to acquire the stored state of the first CRB of message C in memory (read from memory), then can it encrypt the second CRB of the current message C, then it writes the state of the CRB into memory, and so on, arrow downwards represents an operation of writing state into memory, arrow upwards represents an operation of reading state from memory. It can be seen that memory needs to be frequently accessed, the time to access memory is very long when compared to the process time of the CPU, such that the process efficiency of the whole chip and, therefore, the server system, is very low and more energy resources are consumed.

The invention provides a method and system of maintaining the states for the request queue of a hardware accelerator, the method and system reduces the hardware accelerator's read and write operation to memory due to the necessity of storing the state of CRB for processing data specified by CRB and acquiring the state of the data specified by relevant CRB, by adding a hardware state buffer having the same size as the request queue, in which each state buffer buffers the state required for processing the corresponding CRB.

The invention will use content addressable memory (CAM), such memory is a memory that is addressable by content and is a special storage array RAM, its main operating mechanism is to compare an input data entry with all data entries stored in CAM automatically and simultaneously, and decide whether this input data entry matches with data entry stored in CAM; if there is matched data entry, the address information of that data entry is output. CAM is a hardware module, wiring from the respective data entry to CAM is a digital number of data entry. For example, when data entry is 64 bits, if a data entry is input and 7 data entries are stored in CAM, then wirings to CAM are 8×64, resulting in a relatively large area. During the procedure of integrated circuit design, design tools will all provide a CAM module, a design tool can give the required CAM module as long as the digital number of data entry and number of data entry are input.

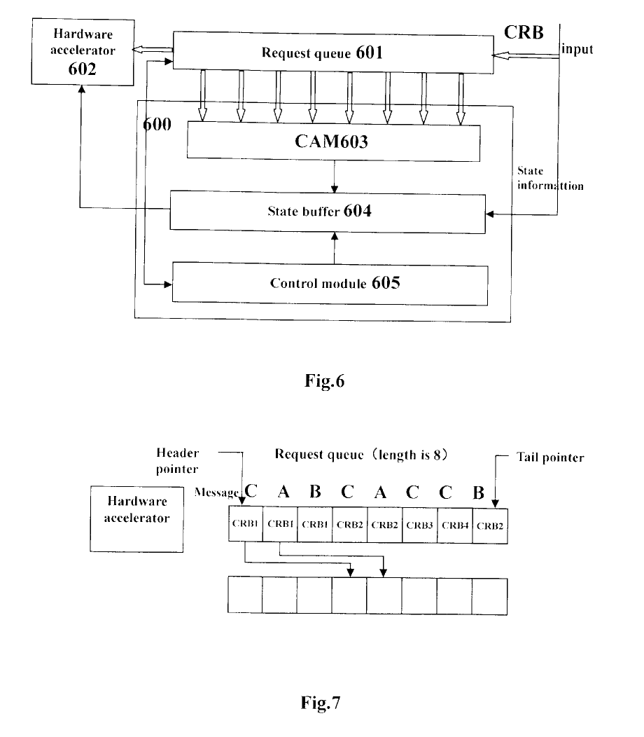

FIG. 6 illustratively shows a structural diagram of a system 600 of maintaining states for the request queue 601 of a hardware accelerator 602 according to an embodiment of the invention, wherein the request queue 601 stores therein at least one CRB to be input into the hardware accelerator 602, the system comprising:
a content addressable memory 603 coupled to the request queue 601 for, in response to a CRB specified by the header pointer of the request queue is about to enter the hardware accelerator 602, receiving the state pointer of the specified CRB, and outputting the physical storage locations of other CRBs in the request queue that are stored in the content addressable memory 603 and are the same as the state pointer of the specified CRB, wherein the content addressable memory 603 stores the state pointer of each CRB in the request queue 601 in the same physical storage location as that of the request queue 601;
a state buffer 604 having the same size as that of the request queue 601, each location thereof stores the state information required for processing CRB of the same location in the request queue 601; and
a control module 605 for, in response to the specified CRB is about to enter the hardware accelerator 602, acquiring from the content addressable memory 603 the physical storage locations of other CRBs in the request queue 601 that are stored in the request queue 601 and are the same as the state pointer of the specified CRB;
controlling the input of the specified CRB and the state information required to process the specified CRB into a hardware buffer 602;
receiving the state information of the specified CRB that has been processed in the hardware accelerator 602;
if the above physical storage locations are not vacant, then making the physical storage location that is closest to the header pointer of the request queue as the selected location and storing the received state information in the selected location of the state buffer 604. In this way, when the CRB in the above-specified location is about to enter the hardware accelerator for the encryption/decryption process, there is no need to acquire the required state information from memory, and as the hardware structure within the chip, the access speed of the hardware buffer is very fast, thereby saving a large amount of time.

FIG. 7 shows a specific example of the embodiment of FIG. 6. CRB1 of message C in FIG. 7 is about to enter the hardware accelerator, first, the state pointer of CRB1 of message C that is about to enter the hardware accelerator is acquired, and the physical storage locations of CRB that is stored in the request queue, and is the same as the state pointer of the new CRB in the request queue, are acquired from CAM, corresponding to FIG. 7, the physical storage locations of CRB2, CRB3 and CRB4 of message C, i.e. 4^{th}, 6^{th} and 7^{th} locations of the request queue, are acquired. If the above physical storage locations are not vacant and there are multiple locations, the physical storage location that is closest to the header pointer of the request queue is taken as the selected location, corresponding to FIG. 7, the header pointer is the location of CRB1 of message C, then the 4^{th} location of the request queue is the selected location; and inputting of CRB that is about to enter the hardware accelerator and the state required for processing the CRB in the corresponding state buffer into the hardware buffer are controlled. The control module 605 then receives the state information of CRB1 of message C that has been processed in the hardware accelerator. The processed state information of CRB1 of message C is stored in the 4^{th} location of the state buffer. In this way, when CRB2 of message C is about to enter the hardware accelerator, the state information required for processing the CRB has already been stored in the state buffer and there is no need to acquire it from memory when needed, thereby reducing the time to access memory due to repeatedly storing the state information. Similarly, when processing CRB1 of the next message A, the processed state information of CRB1 of message A is stored in the 5^{th} location of the state buffer corresponding to CRB2 of message A.

In a preferred embodiment, if the above physical storage locations are vacant, which means that for a current CRB that is about to enter the hardware accelerator there is no CRB in the current request queue that is a different CRB of the same message and there is no corresponding location in the state buffer for placing the state information, the control module stores the received state information in the memory location specified by the state pointer of the specified CRB for use in a subsequent CRB process.

In the above embodiment, controlling the input of the specified CRB and the state information required for processing the specified CRB into the hardware buffer 602, control module 605 first needs to determine whether the state information required for processing a CRB has been stored in the state buffer. If not, the state information needs to be acquired from memory.

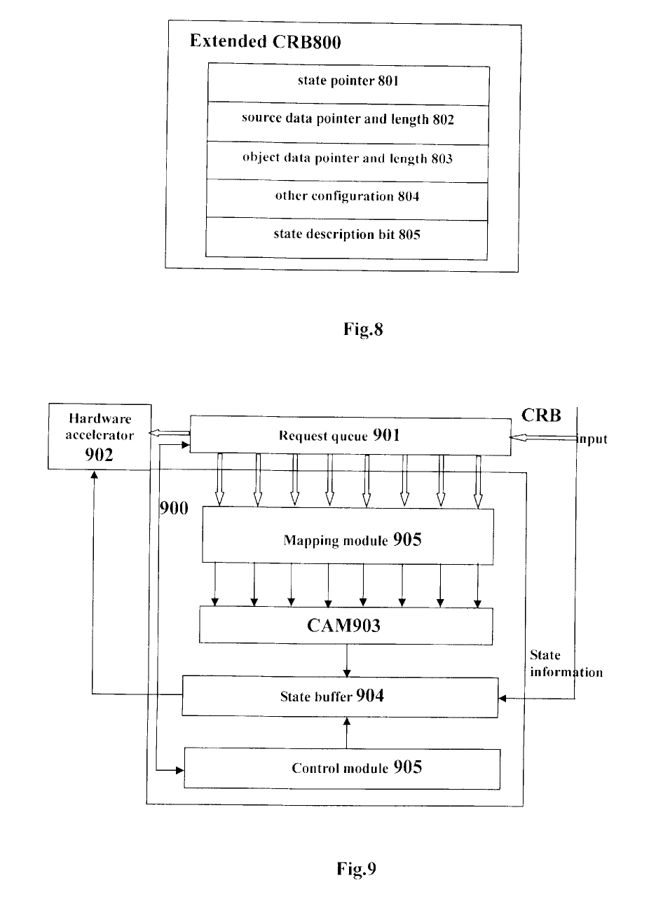

To determine whether the state information required for processing the CRB has been stored in the state buffer, in one embodiment, the structure of CRB in FIG. 2 needs to be further extended such that each CRB contains a state description bit for indicating whether the state information required for processing the CRB has been saved in the state buffer. For example, if the state bit is 1, it indicates that the state required for processing the CRB has been stored in the state buffer, if the state bit is 0, it indicates that the state required for processing the CRB has not been stored in the state buffer; here 0 and 1 are illustrative. Those skilled in the art can select appropriate bits or data, as needed, to indicate whether the state information required for processing the CRB has been stored in the state buffer. This state description bit is preferred and can facilitate the process of the hardware accelerator. However, a CRB may not also contain a state description bit. An additional process may be added in the hardware accelerator to achieve the same purpose. FIG. 8 shows a structural diagram of an extended CRB that further includes a state description bit 805. Those skilled in the art will recognize that FIG. 8 is illustrative and the state description bit 805 may also be a sub-entry in other configurations 804.

In one embodiment, in controlling the input of the specified CRB and the state information required for processing the specified CRB and stored in the same location in the state buffer into a hardware buffer, specific steps performed by the control module further comprise: based on the state description bit of the specified CRB, the control module judges whether the state information required for processing the CRB has been saved in the state buffer; if not, the control module controls the acquisition of the state information required for processing the CRB from memory and controls the input of the specified CRB and the state information required for processing the specified CRB into the hardware buffer. Otherwise, the control module controls the input of the specified CRB and the state information required for processing the specified CRB and stored in the same location in the state buffer into the hardware buffer. In this way, if the state information required when processing CRBs that are about to enter the hardware buffer are all stored in a corresponding state buffer in advance, there will not be such a case that the state information is found to be needed when processed by the hardware accelerator and has to be acquired from external memory. The hardware accelerator needs to wait, resulting in prolonged process times. Subsequent embodiments will illustrate how to perform pre-storage. However, the embodiment of FIG. 6 has already saved a large amount of time even without pre-storage.

In one preferred embodiment, CRB in the request queue should enter the hardware accelerator controlled by the control module, specifically, the control module further comprises a pointer maintaining the module configured to maintain the header pointer and the tail pointer of the request queue, such as those indicated in FIG. 7, in which the header pointer points to a CRB to be input into the request queue of the hardware accelerator, and the tail pointer points to a most recently input CRB in the request queue (it is to be noted here that the distance between the header pointer and the tail pointer is not necessarily the length of the request queue). When a CRB is input into a hardware accelerator and its output state is processed, the header pointer needs to be updated, i.e. the pointer maintaining module, in response to storing the received state information in the selected location of the state buffer or memory location specified by the state pointer of the specified CRB, updates the header pointer of the request queue. During updating, in response to updating the header pointer of the request queue, make the header pointer point to a next CRB in the request queue and make the header pointer point to the first CRB in the request queue if the header pointer originally points to the last CRB in the request queue.

Since the header pointer and the tail pointer are used, the request queue can logically form a loop structure. When the length of the request queue is not reached, it indicates that there are still vacant locations in the request queue and a new CRB may be inserted. The loop structure may get larger with the insertion of the CRB. When the length of the request queue is reached, a new CRB can no longer be inserted. The loop structure can no longer grow larger. At this point, the new CRB can no longer be inserted. Unless a CRB specified by the header pointer of the request queue is added to the hardware buffer and a new location is vacated in the request queue, the new CRB cannot be inserted, i.e. the tail pointer cannot catch up with the header pointer. This should be controlled by the control module, thus controlling the step controlled by the control module. This further comprises:
in response to a request of inserting a new CRB in a location specified by the tail pointer of the request queue, receiving the header pointer and the tail pointer maintained by the pointer maintaining module;
judging whether the number of CRBs between the header pointer and the tail pointer of the request queue is equal to the length of the request queue;
if yes, returning to the judging step;
otherwise, inserting a new CRB in a location specified by the tail pointer of the request queue.

The above controlling step of the control module is a step parallel to the controlling step of the control module in FIG. 6. That is, the request queue is formed as a loop by using the header pointer and the tail pointer of the request queue, in which the header pointer controls the input of CRB into the hardware accelerator and the tail pointer controls insertion of new CRB. The selected location is defined as the physical storage location that is closest to the header pointer on the request queue of the specified CRB, which is the physical storage location that is closest to the header pointer on a directional queue logically arranging CRBs in the request queue from the header pointer to the tail pointer. The header pointer points to the specified CRB. In another embodiment of the physical storage location that is closest to the request queue of the specified CRB, the CRB shown in FIG. 2 may be extended and each CRB further includes a CRB sequence number in the message for specifying the sequence of the CRB in all CRBs describing the message. For example, the sequence number of a first CRB of message A may be A1, and so on. As such, among the physical storage locations of a plurality of CRBs that are the same as the state pointer of the specified CRB in the request queue, it may be judged which is the physical storage location that is closest to the request queue of the specified CRB according to its message sequence number, i.e. the location with the smallest message sequence number is the physical storage location that is closest to the request queue of the specified CRB.

For a newly inserted CRB, the state information required by the hardware accelerator for processing the CRB may or may not be acquired through the manner shown in FIG. 6, i.e. there is no CRB representing a same message as the new CRB in request queue. At this point, the state information may be accessed from memory in advance. Specifically, the control module further includes a pre-fetching module configured to:
in response to inserting a new CRB in a location specified by the tail pointer of the request queue, acquiring the state pointer of the newly inserted CRB;
acquiring the location of a CRB that is the same as the state pointer of the new CRB in the request queue to the header of the request queue, the location is a pre-fetch location, if the pre-fetch location is vacant, then:
   acquiring the state information of the new CRB from memory; and
   storing the acquired state information of the new CRB in the pre-fetch location of the state buffer.

As such, when a new CRB is inserted, it may be judged that, if the state information required for processing the CRB cannot be acquired through the manner of FIG. 6, it will be acquired from memory external to the chip in advance, so the state information probably has already been stored in the state buffer when the CRB needs to be input into hardware accelerator. Even if it has not already been stored in the state buffer, the process of acquiring it from external memory has already begun for a period of time, which achieves the effect of parallel processing, thereby saving a large amount of time. However, the state description bit of CRB in the pre-fetched state should be extended into a 3^{rd} state, so as to prevent the control module from acquiring it from memory again.

At this point, the pointer maintaining module, in response to inserting a new CRB in a location specified by the tail pointer of the request queue and after the pre-fetching module finishes the pre-fetch operation, makes the tail pointer point to a next CRB of the request queue and makes the header pointer point to a first CRB of the request queue if the tail pointer originally points to a last CRB of the request queue.

In one embodiment, the control module further comprises a state updating module. On one hand, this module can update the state description bit of CRB at the selected location of the request queue in response to the received state information stored in the selected location of the state buffer. On the other hand, it can update the state description bit of the new CRB in response to the pre-fetching module storing the state information of the new CRB in the pre-fetch location of the state buffer.

In the above embodiment, the control module may be implemented by hardware logic and the design tool can automatically generate the logic after the function thereof is described by the hardware description language.

Further, since CAM is a hardware module, wiring from respective data entries to CAM is a digital number of data entry, the area of which will be relatively large. Therefore, the above embodiments may be further improved. FIG. 9 shows a structural diagram of a system 900 of maintaining the states for the request queue of a hardware accelerator according to another embodiment of the invention. According to FIG. 9, a mapping module 905 is added in the system 900 of maintaining the states for the request queue of a hardware accelerator and is configured to map the state pointer of CRB in the request queue into the data entry having less bits and input it into the CAM. For example, the state pointer of the original CRB is the location in the memory and is a data entry of 64 bits, wiring to CAM will be 64×8. It may be mapped by mapping the module into the data line of 3 bits, such that wiring to CAM is only 3×8, thereby reducing the chip area. The CRB insertion module in the system in which the mapping module is added may use any CRB insertion module described above.

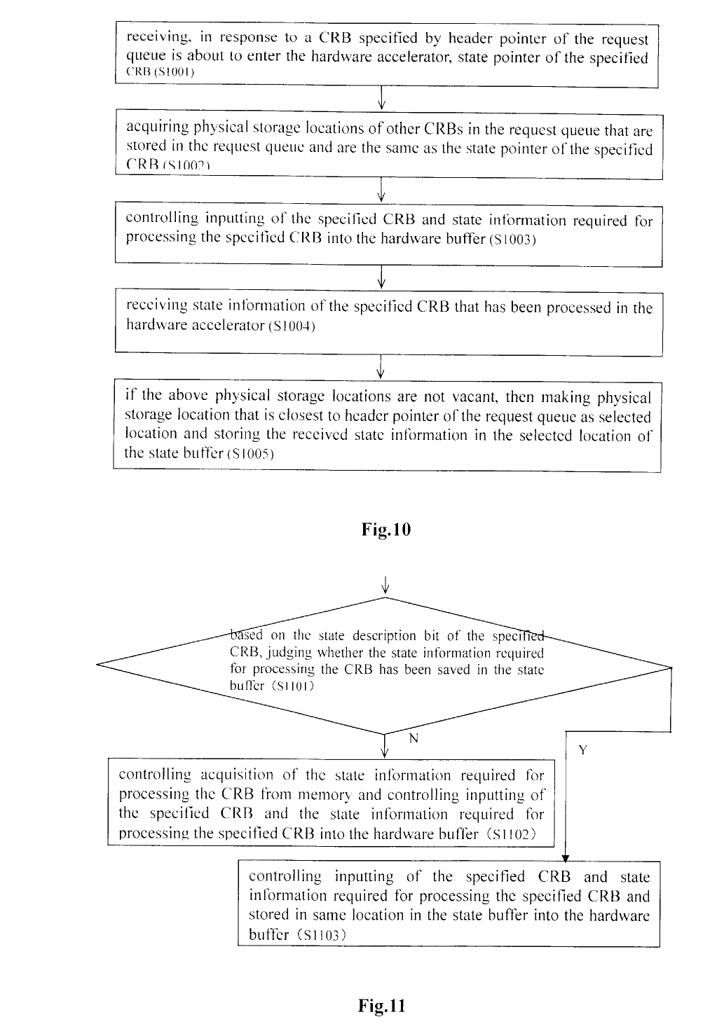

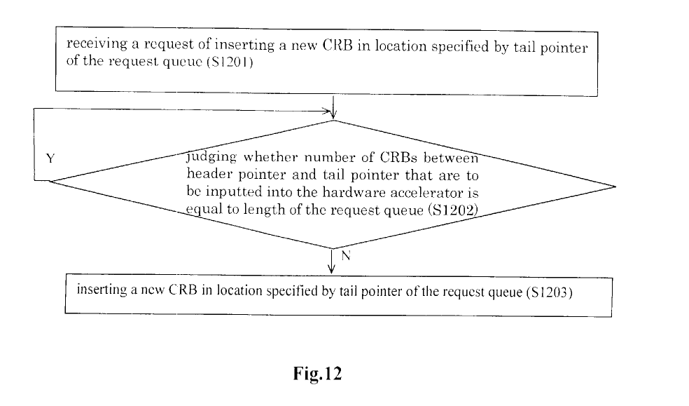

Under a same inventive conception, the invention also discloses a method of maintaining the states for the request queue of a hardware accelerator, wherein the request queue stores therein at least one CRB to be input into the hardware accelerator. FIG. 10 shows a flowchart of a method of maintaining the states for the request queue of a hardware accelerator according to an embodiment of the invention. According to FIG. 10, in step S1001, in response to a CRB specified by the header pointer of the request queue that is about to enter the hardware accelerator, the state pointer of the specified CRB is received. In step S1002, the physical storage locations of other CRBs in the request queue that are stored in the request queue and are the same as the state pointer of the specified CRB are acquired. In step S1003, the input of the specified CRB and the state information required for processing the specified CRB into a hardware buffer are controlled. In step S1004, the state information of the specified CRB that has been processed in the hardware accelerator is received. In step S1005, if the above physical storage locations are not vacant, then physical storage locations that are closest to the header pointer of the request queue are made as the selected location and the received state information is stored in the selected location of the state buffer. Wherein the size of the state buffer is the same as that of the request queue, each location thereof stores the state information required for processing CRB of the same location in the request queue.

In a preferred embodiment, if the above physical storage location is vacant, the received state information is stored in the memory location specified by the state pointer of the specified CRB.

In the above embodiment, in controlling the input of the specified CRB and the state information required for processing the specified CRB into the hardware buffer, it first needs to determine whether the state information required for processing a CRB has been stored in the state buffer. If not, the state information needs to be acquired from memory.

To determine whether the state information required for processing a CRB has been stored in the state buffer, in one embodiment, the structure of CRB in FIG. 2 needs to be further extended such that each CRB contains a state description bit for indicating whether the state information required for processing the CRB is being pre-fetched or has been saved in the state buffer. Thus, the method further comprises: in response to the received state information stored in the selected location of the state buffer, the state description bit of CRB at the selected location of the request queue is updated.

In one embodiment, FIG. 11 shows the detailed steps of step S1003. According to FIG. 11, in step S1003, controlling the input of the specified CRB and the state information required for processing the specified CRB and stored in the same location in the state buffer into a hardware buffer further comprises:
in step S1101, based on the state description bit of the specified CRB, judging whether the state information required for processing the CRB has been saved in the state buffer;
in step S1102, if not, controlling acquisition of the state information required for processing the CRB from memory and controlling the input of the specified CRB and the state information required for processing the specified CRB into the hardware buffer;
otherwise, in step S1103, controlling the input of the specified CRB and the state information required for processing the specified CRB and stored in the same location in the state buffer into the hardware buffer.

In one embodiment, the method shown in FIG. 10 further comprises:
maintaining the header pointer and the tail pointer of the request queue;
specifically, the header pointer of the request queue points to a CRB that is about to enter the hardware accelerator in FIG. 10, thus the step of maintaining the header pointer is relevant to the steps of FIG. 10, in response to storing the received state information in the selected location of the state buffer or memory location specified by the state pointer of the specified CRB, the header pointer of the request queue needs to be updated and, in response to updating the header pointer of the request queue, the header pointer of the request queue needs to point to a next CRB of the request queue and the header pointer needs to point to a first CRB of the request queue if the header pointer originally points to a last CRB of the request queue.

The Tail pointer of the request queue points to a CRB newly added into the request queue, specifically, a new CRB is added to the request queue that can be performed in parallel to the process shown in FIG. 10. FIG. 12 shows the flow of inserting a new CRB in the location specified by the tail pointer of the request queue. In step S1201, a request for inserting a new CRB in the location specified by the tail pointer of the request queue is received. In step S1202, it is judged whether the number of CRBs between the header pointer and the tail pointer that are about to enter the hardware accelerator is equal to the length of the request queue. If yes, return to step S1202, returning to the judging step. Otherwise, in step S1203, a new CRB is inserted in the location specified by the tail pointer of the request queue.

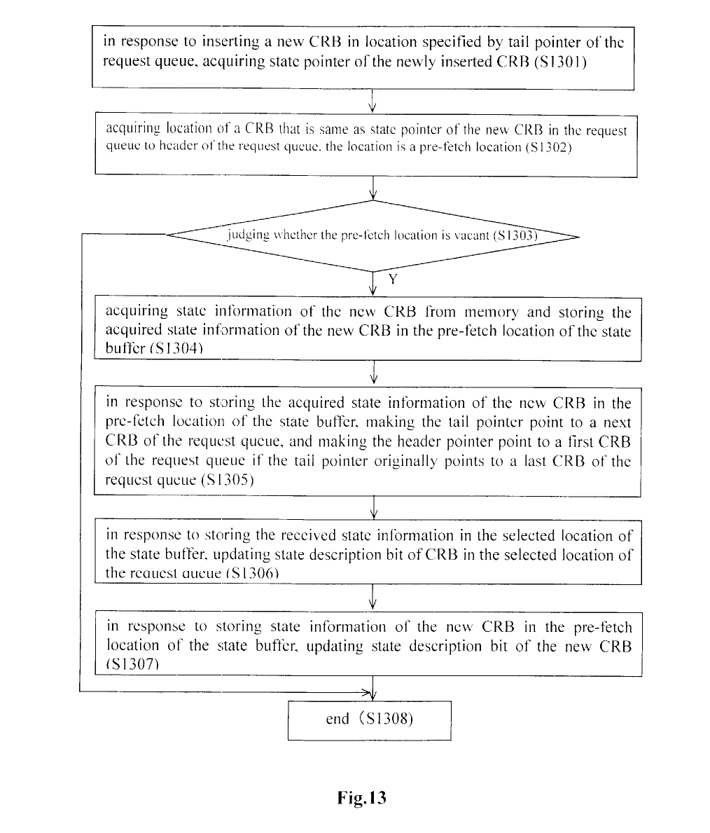

Upon inserting a new CRB in the location specified by the tail pointer of the request queue, it can be judged whether the state information required by the new CRB can be obtained through the steps shown in FIG. 10. If not, the state information can be directly pre-fetched from memory. Specifically, FIG. 13 shows the detailed steps of step S1204. According to FIG. 13, in step S1301, in response to inserting a new CRB in the location specified by the tail pointer of the request queue, the state pointer of the newly inserted CRB is acquired. In step S1302, the location of a CRB that is the same as the state pointer of the new CRB in the request queue to the header of the request queue is acquired. The location is a pre-fetch location. In step S1303, it is judged whether the pre-fetch location is vacant. If not, it means that the state information required by the CRB may be acquired through the flow shown in FIG. 10. The method proceeds to step S1308 where the flow ends. If the pre-fetch location is vacant, step S1304, the state information of the new CRB is acquired from memory and the acquired state information of the new CRB is stored in the pre-fetch location of the state buffer. Preferably, in step S1305, in response to storing the acquired state information of the new CRB in the pre-fetch location of the state buffer, the tail pointer is made to point to a next CRB of the request queue and the header pointer is made to point to a first CRB of the request queue if the tail pointer originally points to a last CRB of the request queue. Further, preferably, in step S1306, in response to storing the received state information in the selected location of the state buffer, the state description bit of the CRB in the selected location of the request queue is updated. Further, preferably, in step S1307, in response to storing the state information of the new CRB in the pre-fetch location of the state buffer, the state description bit of the new CRB is updated. In step S1308, the flow ends.

Under a same inventive conception, the invention also discloses a chip comprising the system of maintaining the states for the request queue of a hardware accelerator as described above.

Although exemplary embodiments of the invention have been described with reference to the accompanying drawings, it should be appreciated that the invention is not limited to these precise embodiments. Those skilled in the art can make various changes and modifications to these embodiments without departing from the scope and spirit of the invention. All these changes and modifications are intended to be included in the scope of the invention as defined by the appended claims.

What is claimed is:

1. A method for maintaining states for a request queue of a hardware accelerator, wherein the request queue stores at least one Coprocessor Request Block (CRB) to be in put into the hardware accelerator, the method comprising:
receiving the state pointer of a CRB specified by said request queue to enter the hardware accelerator;
acquiring physical storage locations of other CRBs in the request queue that are stored in the request queue, which locations are the same as the state pointer of the specified CRB in a state buffer;
controlling the input of the specified CRB and the state information required for processing the specified CRB into a hardware buffer;
determining if said physical locations are vacant;
receiving the state information of the specified CRB that has been processed in the hardware accelerator; and
if said physical locations are not vacant, then determining the physical locations in the request queue that are closest to the selected location, and storing the received state information in the selected location in the state buffer wherein the size of the state buffer is the same as that of the request queue, and each location of the state buffer stores the state information of the CRB at the same location in the request queue.

2. The method of claim 1, wherein if said physical locations are vacant, then storing the received state information at a location specified by the state pointer of the specified CRB.

3. The method of claim 2, further including:
providing a state description bit in said CRB for indicating whether a state in formation required for processing the CRB has been saved in said state buffer, and
based upon the state description bit of the specified CRB, determining whether the state information required for processing the CRB has been saved in the state buffer;
if the state information has not been saved, controlling the acquisition of the state information required for processing the CRB, and controlling the input of the specified CRB and the state information required for processing the specified CRB into the hardware buffer; and
if the state information has been saved, controlling the input, into the hardware buffer of the specified CRB and the state information required for processing the specified CRB and stored in the same location in the state buffer.

4. The method of claim 3 further including a step of providing a header pointer and a tail pointer to the request queue, wherein the header pointer points to a CRB to be input into the request queue of the hardware accelerator, and the tail pointer points to the most recent CRB put into the request queue, the step including, responsive to the storing the received state information in a selected location of the state buffer or storing the memory location indicated by the state pointer of the specified CRB, making the header pointer of the request queue point to a next CRB in the request queue, except if the header pointer originally points to the last CRB in the request queue, then making the header pointer point to the first CRB in the request queue.

5. The method of claim 4 further comprising:
responsive to a request for inserting a new CRB in a location specified by the tail pointer of the request queue, receiving the header pointer and the tail pointer of said request queue;
determining whether the number of CRBs between the header pointer and the tail pointer of the request queue is equal to the length of the request queue;
if said number is equal, then continuing said determining; and
if said number is not equal, then inserting a new CRB in the location specified by the tail pointer of the request queue acquiring the state pointer of the new CRB.

6. The method of claim 5 further comprising:
responsive to inserting a new CRB in a location specified by the tail pointer of the request queue, acquiring the pointer of the new CRB;
acquiring a location of a CRB that is the same as the state pointer of the new CRB in the request to the header of the request queue, wherein said location is a pre-fetch location;
determining whether the pre-fetch location is vacant; and if the pre-fetch location is vacant, then acquiring the state information of the new CRB from memory; and
storing the acquired state information of the new CRB in the pre-fetch location of the state buffer.

7. The method of claim 6, further comprising:
responsive to the storing of the received state information in the selected location of the state buffer, updating the state description bit of the CRB at the selected location of the request queue; and
responsive to storing the state information of the new CRB in the pre-fetch location of the state buffer, wherein the state description bit of the new CRB is updated.

8. The method of claim 7 wherein:
the physical storage location that is closest on the request queue to the specific CRB is one of the following:
the physical storage location with a smallest message sequence number, wherein said smallest message sequence number is included in the CRB and specifies the sequence of the CRB within all CRBs describing the message; or
the physical storage location that is closest to the header pointer in a directional queue wherein CRBs are logically arranged from header pointer to tail pointer in the request queue, and the header points to the specific CRB.

9. A system for maintaining the states for a request queue of a hardware accelerator, wherein the request queue stores at least one Coprocessor Request Block (CRB) to be in put into the hardware accelerator, the system comprising
a processor; and
a computer memory holding computer program instructions which when executed by the processor perform the method comprising:
receiving the state pointer of a CRB specified by said request queue to enter the hardware accelerator;
acquiring physical storage locations of other CRBs in the request queue that are stored in the request queue, which locations are the same as the state pointer of the specified CRB in a state buffer;
controlling the input of the specified CRB and state information required for processing the specified CRB into a hardware buffer;
determining if said physical locations are vacant;
receiving the state information of the specified CRB that has been processed in the hardware accelerator; and
if said physical locations are not vacant, then determining the physical locations in the request queue that are closest to the selected location, and storing the received state information in the selected location in the state buffer wherein the size of the state buffer is the same as that of the request queue, and each location of the state buffer stores the state information of the CRB at the same location in the request queue.

10. The system of claim 9, wherein in said performed method, if said physical locations are vacant, then storing the received state information at a location specified by the state pointer of the specified CRB.

11. The system of claim 10, wherein the performed method further includes:
providing a state description bit in said CRB for indicating whether a state information required for processing the CRB has been saved in said state buffer, and
based upon the state description bit of the specified CRB, determining whether the state information required for processing the CRB has been saved in the state buffer;
if the state information has not been saved, controlling the acquisition of the state information required for processing the CRB, and controlling the input of the specified CRB and the state information required for processing the specified CRB into the hardware buffer; and
if the state information has been saved, controlling the input, into the hardware buffer of the specified CRB and the state information required for processing the specified CRB and stored in the same location in the state buffer.

12. The system of claim 11, wherein the performed method further includes a step of providing a header pointer and a tail pointer to the request queue, wherein the header pointer points to a CRB to be input into the request queue of the hardware accelerator, and the tail pointer points to the most recent CRB put into the request queue, the step including responsive to the storing of the received state information in a selected location of the state buffer or storing the memory location indicated by the state pointer of the specified CRB, making the header pointer of the request queue point to a next CRB in the request queue, except if the header pointer originally points to the last CRB in the request queue, then making the header pointer point to the first CRB in the request queue.

13. The system of claim 12, wherein the performed method further comprises:
responsive to a request for inserting a new CRB in a location specified by the tail pointer of the request queue, receiving the header pointer and the tail pointer of said request queue;
determining whether the number of CRBs between the header pointer and tail pointer of the request queue is equal to the length of the request queue;
if said number is equal, then continuing said determining; and
if said number is not equal, then inserting a new CRB in the location specified by the tail pointer of the request queue acquiring the state pointer of the new CRB.

14. The system of claim 13, wherein the performed method further comprises:
responsive to inserting a new CRB in a location specified by the tail pointer of the request queue, acquiring the pointer of the new CRB;
acquiring a location of a CRB that is the same as the state pointer of the new CRB in the request to the header of the request queue, wherein said location is a pre-fetch location;
determining whether the pre-fetch location is vacant; and if the pre-fetch location is vacant, then acquiring the state information of the new CRB from memory; and
storing the acquired state information of the new CRB in the pre-fetch location of the state buffer.

15. The system of claim 14, wherein the performed method further comprises:
responsive to the storing of the received state information in the selected location of the state buffer, updating the state description bit of the CRB at the selected location of the request queue; and
responsive to the storing of the state information of the new CRB in the pre-fetch location of the state buffer, wherein the state description bit of the new CRB is updated.

16. The system of claim 15, wherein in the performed method:
the physical storage location that is closest on the request queue of the specific CRB is one of the following:
the physical storage location with a smallest message sequence number, wherein said smallest message sequence number is included in the CRB and specifies the sequence of the CRB within all CRBs describing the message; or
the physical storage location that is closest to the header pointer in a directional queue wherein CRBs are logically arranged from header pointer to tail pointer in the request queue, and the header points to the specific CRB.

17. An integrated circuit chip including the system of claim 9.
